(19) United States
(12) Patent Application Publication
(10) Pub. No.: US 2002/0117987 A1
(43) Pub. Date: Aug. 29, 2002

(54) Force feedback manual pulse generator

(76) Inventors: Fei-Hsu Chen, Taichung City (TW); Chao-Chuang Mai, Tai-Pin City (TW); Wen-Jui Chen, Chang-Fah City (TW)

Correspondence Address: Keith Kline, PRO-TECHTOR INTERNATIONALSERVICES, 20775 Norada Court, Saratoga, CA, 95070-3018, US

(21) Appl. No.: 09/793,157

(22) Filed: Feb. 24, 2001

(51) Int. Cl. F16H 3/72; F16H 37/06

(52) U.S. Cl. 318/569; 475/4

(57) ABSTRACT

A force feedback manual pulse generator, comprising a driver and a motor, driving a saddle of a machine tool along an axis for advancing a cutting tool, a CNC controlling device, issuing commands for controlling the driver to drive the motor, a manual pulse generator, and, as the main characteristic, a braking system and a force feedback unit. The manual pulse generator has a handwheel, operated by a user, and an encoder, generating a signal according to a turning movement of the handwheel for controlling the driver to drive the motor. The braking system is mounted on the manual pulse generator, creating a braking force and thus increasing resistance to the turning movement of the handwheel. The force feedback unit senses load experienced by the motor when driving the saddle and controlling the braking system. This is done in a way that upon increasing load of the motor the braking force is increased, so that the user, when turning the handwheel, feels resistance to cutting.

### BACKGROUND OF THE INVENTION

1. Field of the Invention

The present invention relates to a force feedback manual pulse generator, particularly to a force feedback manual pulse generator for use at an electronic-pulse generator of a CNC machine tool.

2. Description of Related Art

Conventionally, for controlling traversing of saddle and tools of a CNC machine tool, mainly a manual electronic-pulse generator is used. A CNC controller and an auxiliary system drive saddle and tools to perform a traversing movement.

An electronic-pulse generator of a CNC machine tool by electronic dividing is able to generate minute and precise tool traversing movements. Furthermore, an electronic system does not require a complicated mechanism and occupies only a small volume, thus being suitable for CNC machine tools. Therefore, this kind of manual electronic-pulse generators for CNC machine tools is widely used in the world of CNC machine tooling.

However, in spite of the precision of a manual electronic-pulse generator, when the tool traversing movement of the machine tool is controlled manually, there is no way to get a feedback of force and vibrations during the traversing movement, as in conventional systems using leadscrews and gears. Therefore an inappropriate movement of the tool will result. When resistance of a moving tool or slide increases, a conventional mechanical handwheel lets a user feel the increased resistance, signaling an irregular state, upon which the tool will be slowed down to prevent damaging of the cutting tool and the machine tool. The user judges by experience which advance and speed are appropriate to preserve precision of the cutting edge.

On the other hand, since an auxiliary system of an electronically working manual pulse generator drives the traversing movement by oil pressure or electrically, no resistance encountered by the tool is fed back to the manual pulse generator. Therefore the user will not notice any change of forces. When the machine tool meets irregular resistance, speed of cutting will remain unchanged, which readily leads to damaging of the cutting tool and the machine tool. Furthermore, since actual resistance is not sensed, there is no way to judge proper cutting by the feel at turning of the manual pulse generator, so that working of the cutting edge will be impaired.

### SUMMARY OF THE INVENTION

The main object of the present invention is to provide a force feedback manual pulse generator, transferring resistance encountered by a machine tool at a traversing movement to a resistance at turning of a handwheel, so that a user feels what resistance the machine tool actually encounters.

The force feedback manual pulse generator of the present invention has a small brake at an encoder of the manual pulse generator. The brake creates friction on a rotational axis of the manual pulse generator after having sensed a load or resistant force encountered by a driving device of the machine tool for traversing a cutting tool. The amount of load or resistant force controls a braking pressure. Thus the user, by feeling changing resistance of the manual pulse generator, is able to notice any change in resistance to cutting, so as to prevent an improper cutting movement and to judge on an appropriate degree of cutting. Thereby damaging of the cutting tool is avoided, and preciseness of the cutting edge is enhanced.

The present invention can be more fully understood by reference to the following description and accompanying drawings.

### BRIEF DESCRIPTION OF THE DRAWINGS

FIG. 1 is a schematic illustration of the force feedback manual pulse generator of the present invention.

FIG. 2 is a control flow chart of the force feedback manual pulse generator of the present invention.

### DETAILED DESCRIPTION OF THE PREFERRED EMBODIMENT

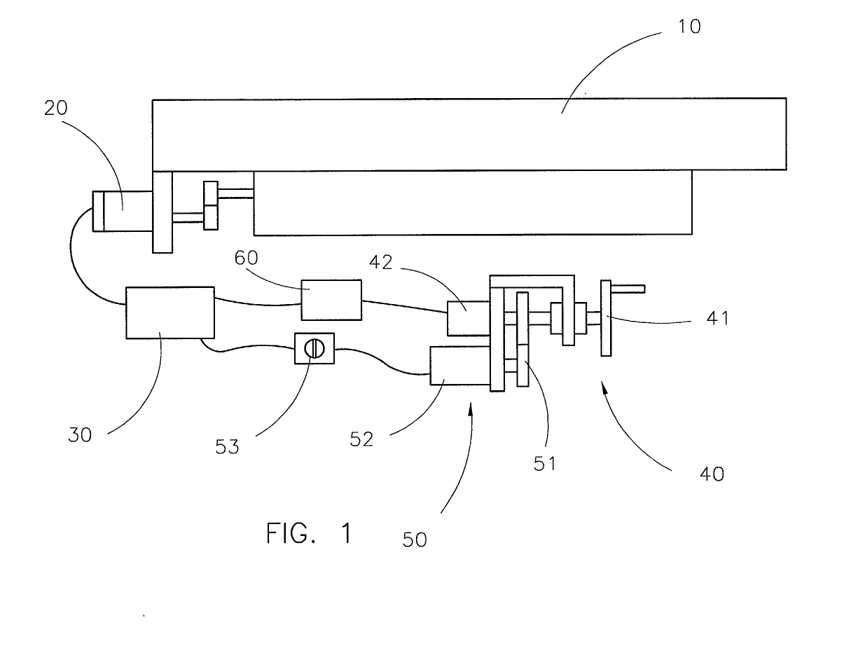

As shown in FIG. 1, the force feedback manual pulse generator of the present invention is used in conjunction with a machine tool, forming a structure having: a saddle 10, moving along a central axis, taking along a work object or a cutting tool in a traversing movement; a motor 20, driving the saddle 10; a driver 30, controlling a movement of the motor 20; and a manual pulse generator 40. The manual pulse generator 40 comprises: a handwheel 41, turned by a user for controlling the traversing movement of the saddle 10; and an encoder 42, driven by the handwheel 41. The encoder 42 generates a signal that is transmitted to a CNC controlling device 60. The CNC controlling device 60 in turn generates a command for the driver 30, causing the driver 30 to control the movement of the motor 20.

The encoder 42 senses turning of the handwheel 41, dividing a turning movement thereof into a plurality of minute degrees. The minute degrees are converted into a signal which is transmitted to the CNC controlling device 60. The CNC controlling device 60 further transmits a converted signal to the driver 30. By controlling of the driver 30, the motor 20 performs a movement according to the signal of the encoder 42. Thus the encoder 42 and the CNC controlling device 60 via the driver 30 control the motor 20, so as to drive the saddle 10 to move along the central axis in a precise manner.

The main characteristic of the present invention is a braking device 50, mounted on the manual pulse generator 40. The braking device 50 comprises: a contact element 51; a driving device 52; and a load feedback regulator 53. The contact element 51 touches a rotating disc on the handwheel 41, applying resistance to the rotating movement thereof by friction. The driving device 52 drives the contact element 51 to touch the handwheel 41 and is further connected with the driver 30. The driving device 52 is controlled by the driver 30 to vary a contact pressure of the contact element 51 on the handwheel 41 and thus to vary the resistance to the rotating movement thereof. The load feedback regulator 53 is inserted between the driver 30 and the driving device 52, allowing the user to adjust the contact pressure of the braking device 50, so as to adapt the contact pressure to the user's practice. The CNC machine tool in a possible setup has several coaxial shafts, each being equipped with a driver 30 and a force feedback unit 31 of its own. The load feedback regulator 53 works electronically and is connected to the various force feedback units 31 on the several shafts, taking load feedback from multiple shafts. A switch allows to select a feedback signal for the handwheel 41. Thus multiple control is achieved by a single device.

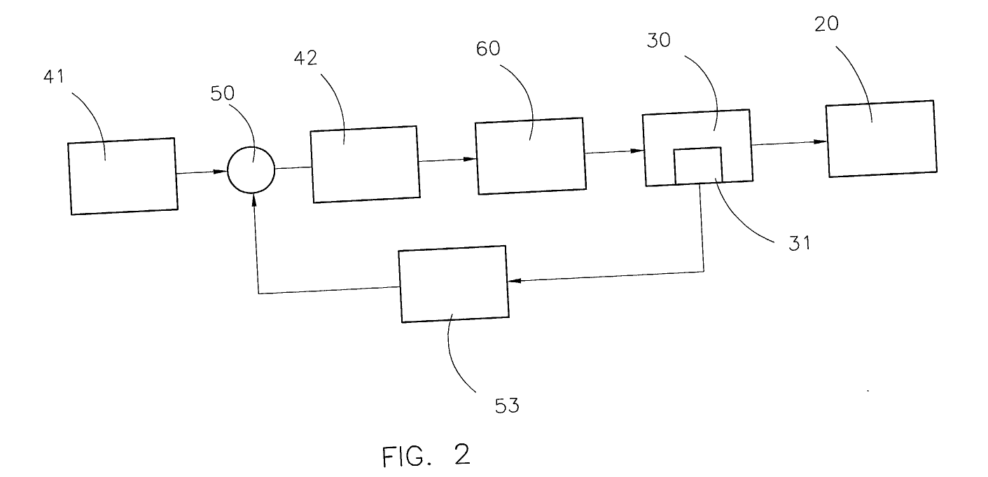

Referring to FIG. 2, operation of the present invention is done as follows. The encoder 42, taken along by the handwheel 41, generates a pulse signal, which is transmitted to the CNC controlling device 60, controlling a cutting depth. Then the driver 30 causes the motor 20 to drive the traversing movement of the saddle 10 along the central axis. Furthermore, a force feedback unit 31 is connected with the driver 30, sensing a load and resistant force experienced by the motor 20 when driving the saddle 10. The load and resistant force sensed is converted into a control signal which is transmitted to the driving device 52 of the braking device 50. Thus the driving device 52 generates friction according to the load and resistant force sensed by the force feedback unit 31.

Thereby the force feedback manual pulse generator of the present invention, by controlling the braking device 50 acting on the manual pulse generator 40 according to the force feedback unit 31, allows the user when operating the manual pulse generator 40 to feel changing resistance to cutting. Therefore an electronically working manual pulse generator provides a feel as a mechanical handwheel.

Therefore the force feedback manual pulse generator of the present invention prevents the user from advancing the cutting tool too far or too fast, which would damage the cutting tool. The feel provided by the force feedback manual pulse generator of the present invention allows the user to judge the proper amount of advancing the cutting tool, enhancing precision of the cutting edge. Furthermore, since the present invention preserves the feel of a mechanical handwheel, a user who is accustomed to a conventional working machine tool or to manual working will have the same feeling when operating the force feedback manual pulse generator of the present invention.

While the invention has been described with reference to a preferred embodiment thereof, it is to be understood that modifications or variations may be easily made without departing from the spirit of this invention which is defined by the appended claim.

1. A force feedback manual pulse generator, comprising:
a driver and a motor, driving a saddle of a machine tool along an axis for advancing a cutting tool;
a CNC controlling device, issuing commands for controlling said driver to drive said motor;
a manual pulse generator, further comprising
a handwheel, operated by a user, and
an encoder, generating a signal according to a turning movement of said handwheel for controlling said driver to drive said motor;
a braking system, mounted on said manual pulse generator, creating a braking force and thus increasing resistance to said turning movement of said handwheel; and
at least one force feedback unit, sensing load experienced by said motor when driving said saddle and controlling said braking system in a way that upon increasing load of said motor said braking force is increased, so that said user, when turning said handwheel, feels resistance to cutting.

2. A force feedback manual pulse generator according to claim 1, further comprising a load feedback regulator, adjusting which quantity of said braking force is received by said braking system from said feedback unit.

3. A force feedback manual pulse generator according to claim 1, wherein said machine tool has several shafts, each separately being provided with an instance of said feedback unit, which is respectively connected with said braking system, with a switch allowing to select one of said instances of said feedback unit for transmission of a feedback signal to said braking system.
